(19) United States
(12) Patent Application Publication
(10) Pub. No.: US 2024/0255630 A1
(43) Pub. Date: Aug. 1, 2024

(54) METHOD FOR ESTIMATING THE HEIGHTS OF OBJECTS BY MEANS OF ULTRASONIC SENSOR TECHNOLOGY

(71) Applicant: Continental Autonomous Mobility Germany GmbH, Ingolstadt (DE)

(72) Inventors: Wassim Suleiman, Kriftel (DE); Christopher Brown, Seligenstadt (DE); Nicolai Glatz, Frankfurt am Main (DE)

(73) Assignee: Continental Autonomous Mobility Germany GmbH, Ingolstadt (DE)

(21) Appl. No.: 18/292,431

(22) PCT Filed: Jun. 29, 2022
(86) PCT No.: PCT/DE2022/200146

§ 371 Date: Jan. 26, 2024

(30) Foreign Application Priority Data
Jul. 27, 2021 (DE) 10 2021 208 072.3

(51) Int. Cl. G01S 7/539; G01S 15/87; G01S 15/931

(52) U.S. Cl. CPC G01S 7/539; G01S 15/876; G01S 15/931

(57) ABSTRACT

A method for classifying the height of an object by at least one vehicle ultrasonic sensor is disclosed. A computer receives at least two ultrasonic signals, calculates a first item of height information based on two items of spacing information relating to at least one vehicle ultrasonic sensor and the object, and calculates a variance of the first item of information. The computer similarly calculates a second item of height information and a variance thereof from a received further ultrasonic signal. The computer combines the items of height information as an average thereof, and the calculated variances of items of height information as an averaged variance thereof. The object is classified in a height class by calculating a probability value based on a distribution function which has as a mean value the averaged item of height information and as a variance the averaged variance of the height information.

### CROSS-REFERENCE TO RELATED APPLICATIONS

The present application is a National Stage Application under 35 U.S.C. § 371 of International Patent Application No. PCT/DE2022/200146 filed on Jun. 29, 2022, and claims priority from German Patent Application No. 10 2021 208 072.3 filed on Jul. 27, 2021, in the German Patent and Trademark Office, the disclosures of which are herein incorporated by reference in their entireties.

### TECHNICAL FIELD

The invention relates to a method for estimating the heights of objects in the region surrounding vehicles by means of ultrasonic sensor technology.

### BACKGROUND

The process of capturing surroundings information in the region of a vehicle by means of ultrasonic sensors, in order to capture the spacing from other objects during parking, for example, is known.

Ultrasonic sensors supply spacing information based on the transit time of the ultrasonic signal, but no direct height information of the detected object, since the reception angle from which the back-reflection occurs cannot be established.

However, the process of establishing the height of the object at which the reflection occurs by evaluating the geometric relationships from multiple transmitting/receiving cycles is known. Thus, the height of the object may be calculated, for example, during a movement of the vehicle between the two transmitting/receiving cycles by evaluating the spacing information measured between the ultrasonic sensor and the reflecting object and an item of distance information which indicates the spacing of the sensor positions of the ultrasonic sensor in the horizontal direction along the direction of propagation of the ultrasonic signal between the ultrasonic sensor and the reflecting object.

The problem with this is that noise frequently results in poor measurement results which lead to inadequate estimation of heights with large deviations.

### SUMMARY

Proceeding herefrom, it is the object of the present disclosure to indicate a method for estimating the heights of objects in the region surrounding vehicles by means of ultrasonic sensor technology, which allows the height of the reflecting object to be reliably estimated.

The object is achieved by a method having the features of the independent claim 1. Example embodiments are the subject-matter of the subclaims. A system for estimating the height of an object is the subject-matter of the alternative, independent claim 15.

According to a first aspect, the present disclosure relates to a method for estimating the height of an object by means of the ultrasonic sensor technology of a vehicle. The method includes the following steps.

Initially, at least two ultrasonic signals are received by at least one ultrasonic sensor. A single ultrasonic sensor may have different sensor positions relative to the object due to a vehicle movement. That is to say that, in other words, items of reception information of an individual ultrasonic sensor are evaluated, the individual ultrasonic sensor taking up different positions, due to the vehicle movement, relative to the object, the height of which is to be established, in consecutive measuring cycles. Alternatively, multiple ultrasonic sensors may also receive the at least two ultrasonic signals, wherein these have different sensor positions relative to the object due to the vehicle movement and/or a different arrangement on the vehicle.

A first item of height information which is a measure of the squared height of the object is then calculated. The height of the object may be the relative height of the object to the installation height of the at least one ultrasonic sensor on the vehicle. In other words, the height of the object is therefore not directly determined, but rather the squared height, in order to thereby avoid misestimations which are caused by noise. The first height information is calculated based on two items of spacing information measured between the respective sensor position and the object, and an item of distance information measured horizontally between the sensor positions. The first height information is, for example, established in a first measuring cycle.

The variance of the first height information is then calculated.

Subsequently, at least one further ultrasonic signal is received by the at least one ultrasonic sensor. Based on the further ultrasonic measurement, a second item of height information which is a measure of the squared height of the object is calculated. The calculation is, in turn, effected based on two items of spacing information measured between the respective sensor position and the object, and an item of distance information measured horizontally between the sensor positions. At least one part of this information which is necessary for the calculation originates from the further ultrasonic measurement which, for example, forms a second measuring cycle. The second measuring cycle may be a measuring cycle immediately following the first measuring cycle, or further measuring cycles may lie between the first and second measuring cycle. If the first and second measuring cycles do not immediately follow one another, the outcome is, for example, that the vehicle moves between the first and second measuring cycle on a longer route, which increases the accuracy of the height estimation.

The variance of the second height information is then calculated.

In a further step, an averaged item of height information is calculated by combining the first and second height information and an averaged variance of the height information is calculated by combining the variance of the first and second height information.

A detected object is classified in a height class by calculating at least one probability value based on a normal distribution function which has as the mean value the averaged height information and as the variance the averaged variance of the height information.

The technical advantage of the method according to the present disclosure is that the height of the reflecting object may be reliably established by determining an item of height information which takes into account the squared height of the object. As a result, with repeated use, a distribution of values of items of height information is achieved, which corresponds better to a normal distribution than when the unsquared height of the object is determined directly.

According to an example embodiment, further items of height information (i.e., additional items of height information in addition to the first and second items of height information), which are a measure of the squared height of the object, and items of variance information regarding the further items of height information are calculated iteratively. The averaged height information is determined by combining the items of height information, such as all of the iteratively determined items of height information, and an averaged variance of the items of height information is determined by combining the variances of the items of height information, such as all of the iteratively established variances. A reliable classification of the height of the object may be achieved by the iterative determination of a plurality of items of height information and the variances thereof, and combining the items of height information.

According to an example embodiment, the first, second and/or further height information is calculated by the following formula:

$$H = {h}^{2} = {r}_{1}^{2} - \frac{{( {r}_{1}^{2} - {r}_{2}^{2} + {s}^{2} )}^{2}}{4 {s}^{2}} ;$$

wherein the following applies:
   h: height difference between the at least one ultrasonic sensor and the object;
   r₁: spacing between a first transmitter position and the object in the transmitting and receiving direction;
   r₂: spacing between a second transmitter position and the object in the transmitting and receiving direction;
   s: distance information measured in the horizontal direction as the spacing between the first and second sensor position.

In contrast to the direct determination of the height difference h, the aforementioned formula does not contain a root term, which means that negative values of H or the squared height h, which can arise from noise, do not lead to invalid results.

According to an exemplary embodiment, the variance of the first, second and/or further height information is established based on a first-order variation analysis. The variance of the height information may be calculated by the variation analysis by adding multiple summands, wherein the summands in each case take into account the change in the height information as a function of the change in an input variable which is enlisted to calculate the height information.

According to an example embodiment, the variance of the first, second and/or further height information is calculated by the following equation:

$$Var [ H ] = {( \frac{dH}{{dr}_{1}} )}^{2} \cdot Var [ {r}_{1} ] + {( \frac{dH}{{dr}_{2}} )}^{2} \cdot Var [ {r}_{2} ] + {( \frac{dH}{ds} )}^{2} \cdot Var [ s ] ;$$

wherein the following applies:
   r₁: spacing between a first transmitter position and the object in the transmitting and receiving direction;
   r₂: spacing between a second transmitter position and the object in the transmitting and receiving direction;
   s: distance information measured in the horizontal direction as the spacing between the first and second sensor position;

$$\frac{dH}{{dr}_{1}} :$$

first derivative of the height information H according to r₁;

$$\frac{dH}{{dr}_{2}} :$$

first derivative of the height information H according to r₂;
dH/ds: first derivative of the height information H according to s;
Var[r₁]: variance of the spacing between a first transmitter position and the object in the transmitting and receiving direction;
Var[r₂]: variance of the spacing between a second transmitter position and the object in the transmitting and receiving direction;
Var[s]: variance of the distance information measured in the horizontal direction as the spacing between the first and second sensor position.

According to an exemplary embodiment, the averaged height information is calculated based on the following formula:

$$\overline{H} = \frac{Var [ {H}^{″} ] \cdot {H}^{′} + Var [ {H}^{′} ] \cdot {H}^{″}}{Var [ {H}^{′} ] + Var [ {H}^{″} ]} ;$$

wherein the following applies:
   H′: estimated items of height information from a first measuring cycle;
   H″: estimated items of height information from a second measuring cycle;
   Var[H′]: variance of the height information in the first measuring cycle;
   Var[H″]: variance of the height information in the second measuring cycle.

Either items of height information, which originate from individual measurements, or the estimated height information may be already averaged items of height information, i.e., even produced from an averaging over multiple measurements, may be used as the estimated height information from the respective measuring cycles. The same applies analogously to the variance of the height information in the first and/or second measuring cycle.

According to an example embodiment, the averaged variance of the height information is calculated based on the following formula:

$$\overline{Var [ H ]} = \frac{1}{\frac{1}{Var [ {H}^{′} ]} + \frac{1}{Var [ {H}^{″} ]}} ;$$

wherein the following applies:
   Var[H′]: variance of the height information in the first measuring cycle;
   Var[H″]: variance of the height information in the second measuring cycle.

According to another example embodiment, the averaged height information and the averaged variance of the height information are calculated based on a least squares method. Weighting factors (weighted least squares method) may be used, which are selected in such a way that they take into account an existing correlation between the measurements.

According to an example embodiment, the probability value for assigning the object to a height class is calculated based on the following formula:

$$p = {\int }_{a}^{b} N ( x , \overline{H} , \overline{Var [ H ]} ) dx ;$$

wherein the following applies:
   N(x, H̅, V̅a̅r̅[̅H̅]̅): normal distribution;
   a: lower limit for allocation to the respective height class;
   b: upper limit for allocation to the respective height class;
   H̅: averaged height information;
   V̅a̅r̅[̅H̅]̅ averaged variance.

Therefore, the probability that an object is located in a height range fixed by the lower or upper limit may be determined by assuming a normal distribution of the height information around the averaged height information as the mean value and having a variance equal to the averaged variance.

According to an example embodiment, the height class is calculated based on a correction function which takes into account the deviation of the statistical distribution of the height information from the normal function. As a result, the error which results from the deviation of the statistical distribution of the height information from the normal function may be minimized.

According to an example embodiment, the correction function is estimated based on a stream of height information data which were established based on different items of spacing information between the respective sensor position and the object and different items of horizontally measured distance information. In other words, it is therefore analyzed what influence the items of spacing information or the items of distance information have on the statistical distribution of the items of height information, and the correction function is selected depending on this.

According to an example embodiment, a lower and/or upper limit used for the calculation of the probability value is/are adjusted based on the correction function. As a result, the deviation of the statistical distribution of the height information from the normal function may be compensated for by adapting the lower and/or upper limit(s) during the determination of the height of the object.

According to an example embodiment, the distance information is established based on the vehicle's odometry data. In other words, an odometry system of the vehicle may provide information which indicates how the vehicle has moved between two measuring cycles of the at least one ultrasonic sensor. Since the movement of the vehicle does not necessarily have to take place in the transmitting or receiving direction of the ultrasonic sensor, the distance information, i.e., the spacing of the sensor positions in the transmitting or receiving direction of the ultrasonic sensor, must be calculated from the vehicle's odometry data.

According to an example embodiment, the object is assumed to be a line object having a longitudinal alignment, and the transmitting and receiving direction of the at least one ultrasonic sensor and the direction in which the distance information is measured is assumed to be perpendicular to the longitudinal alignment of the line object.

According to an alternative example embodiment, the object is simulated by means of items of information, which were established by the ultrasonic sensor technology in multiple capturing cycles, by an object contour line, and the items of distance information are assumed to be the difference between the horizontally measured spacing of the sensor positions and the line.

According to a further aspect, the present disclosure relates to a system for estimating the height of an object, including ultrasonic sensor technology provided on a vehicle and a computer unit, wherein the system is configured to carry out the following steps of:
a) receiving at least two ultrasonic signals by at least one ultrasonic sensor of the ultrasonic sensor technology, wherein a single ultrasonic sensor has different sensor positions relative to the object due to a vehicle movement or wherein multiple ultrasonic sensors have different sensor positions relative to the object due to the vehicle movement and/or a different arrangement on the vehicle;
b) calculating a first item of height information which is a measure of the squared height of the object, based on two items of spacing information measured between the respective sensor position and the object, and an item of distance information measured horizontally between the sensor positions by the computer unit;
c) calculating the variance of the first height information by the computer unit;
d) receiving at least one further ultrasonic signal by the at least one ultrasonic sensor and calculating a second item of height information which is a measure of the squared height of the object, based on two items of spacing information measured between the respective sensor position and the object, and an item of distance information measured horizontally between the sensor positions;
e) calculating the variance of the second height information;
f) calculating an averaged item of height information by combining the first and second height information and an averaged variance of the height information by combining the variance of the first and second height information;
g) classifying a detected object in a height class by calculating at least one probability value by the computer unit based on a normal distribution function which has as the mean value the averaged height information and as the variance the averaged variance of the height information.

Within the meaning of the present disclosure, the expressions “approximately”, “substantially” or “roughly” mean deviations from the exact value in each case by +/−10%, such as by +/−5%, and/or deviations in the form of changes which are insignificant to the function.

Further developments, advantages and possible applications of the present disclosure are set out by the following description of example embodiments and by the figures. All of the features described and/or pictured per se or in any combination are fundamentally the subject-matter of the present disclosure, independently of their combination in the claims or references back thereto. The content of the claims is also made an integral part of the description.

### BRIEF DESCRIPTION OF THE DRAWINGS

The present disclosure is explained in greater detail below on the basis of the figures with reference to example embodiments, wherein:

FIG. 1 shows, by way of example and schematically, a vehicle having ultrasonic sensor technology, including multiple ultrasonic sensors distributed around the circumference of the vehicle and a computer unit for evaluating the information provided by the ultrasonic sensor technology;

FIG. 2 shows, by way of example and schematically, the capturing of a surrounding object by an ultrasonic sensor from two different sensor positions;

FIG. 3 shows, by way of example and schematically, a histogram which shows the statistical distribution of the height information H; and

FIG. 4 shows, by way of example, a flowchart which illustrates the steps of a method for determining the height of an object.

### DETAILED DESCRIPTION

FIG. 1 shows, by way of example and in a rough schematic manner, a vehicle 1. The vehicle 1 has a plurality of ultrasonic sensors 2, by means of which the surroundings are successfully captured.

The ultrasonic sensors 2 are coupled to at least one computing unit 4, by means of which the method described below for estimating the height of an object 3 in the environment of a vehicle 1 is affected.

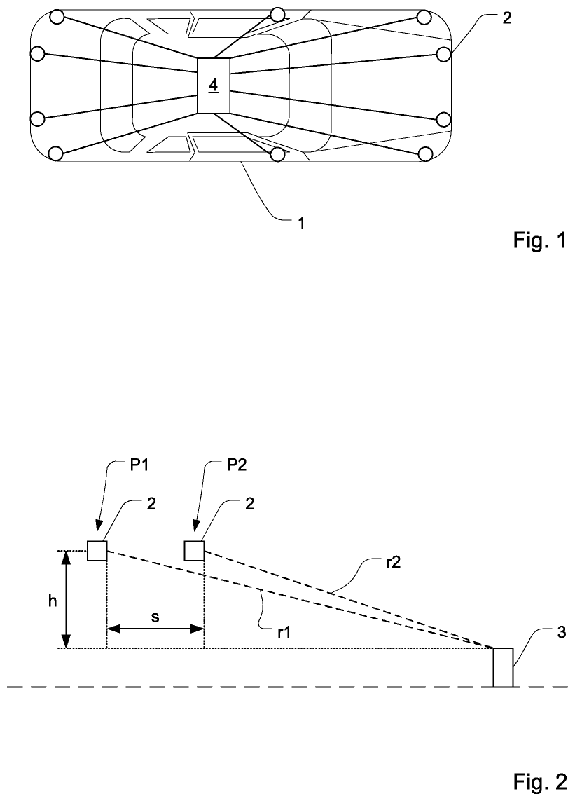

FIG. 2 shows, by way of example, a capturing situation, in which an object 3 which is lower than the installation height of the ultrasonic sensor 2 on the vehicle 1 is captured by means of an ultrasonic sensor 2 of a vehicle 1.

The height of the object 3 may either be determined in that either multiple measurements are performed by a single ultrasonic sensor 2, wherein, for example, a first measurement is carried out at a first sensor position P1 and a second measurement is carried out at a second sensor position P2 and the sensor positions P1 and P2 are different due to the movement of the vehicle 1 or, alternatively, the height of the object 3 may also be determined by at least two measurements of different ultrasonic sensors 2 of the vehicle, which are arranged at different positions on the vehicle 1 and therefore have a different spacing from the object 3.

As shown in FIG. 2, a first item of spacing information r1 is established by the ultrasonic sensor 2 which is located at the first sensor position P1. The first spacing information r1 corresponds to the spacing measured in the direct line of sight between the ultrasonic sensor 2 located at the position P1 and the object 3. In a similar way, a second item of spacing information r2 is established by the ultrasonic sensor 2 which is located at the second sensor position P2. The second spacing information r2 corresponds to the spacing measured in the direct line of sight between the ultrasonic sensor 2 located at the position P2 and the object 3.

The spacing between the first and second sensor positions p1, p2 measured horizontally in the direction of the connecting line between the sensor 2 and the object 3 is referred to below as distance information s. The vertically measured difference in height between the object 3 and the ultrasonic sensor 2 is referred to below as the height h.

Due to geometrical relationships, the height h may be calculated as follows:

$$h = \sqrt{{r}_{1}^{2} - \frac{{( {r}_{1}^{2} - {r}_{2}^{2} + {s}^{2} )}^{2}}{4 {s}^{2}}} \qquad ( Formula 1 )$$

wherein:
   h: height difference between the at least one ultrasonic sensor and the object;
   r₁: spacing between a first transmitter position and the object in the transmitting and receiving direction;
   r₂: spacing between a second transmitter position and the object in the transmitting and receiving direction;
   s: distance information measured in the horizontal direction as the spacing between the first and second sensor position.

The problem is that noise may cause the term under the root to become negative, therefore making it impossible to calculate the height.

A method of classifying heights of the object 3 is disclosed below, which avoids the problem of the negative term under the root.

Instead of the height h, the method according to the present disclosure estimates an item of height information H which corresponds to the square of the height h.

$$H = {h}^{2} = {r}_{1}^{2} - \frac{{( {r}_{1}^{2} - {r}_{2}^{2} + {s}^{2} )}^{2}}{4 {s}^{2}} \qquad ( Formula 2 )$$

In turn:
h: height difference between the at least one ultrasonic sensor and the object;
r₁: spacing between a first transmitter position and the object in the transmitting and receiving direction;
r₂: spacing between a second transmitter position and the object in the transmitting and receiving direction;
s: distance information measured in the horizontal direction as the spacing between the first and second sensor position.

Since individual measurements may be highly error-prone and therefore lead to incorrect height estimations, multiple measurements are carried out and a height estimation of the object 3 or a height classification is carried out based on an averaging of the estimated items of height information H and the estimation of the variance of the items of height information H.

In order to determine the variance of the items of height information H, a first-order variational analysis is, for example, carried out.

For example, this may be done based on the following formula:

$$Var [ H ] = {( \frac{dH}{{dr}_{1}} )}^{2} \cdot Var [ {r}_{1} ] + {( \frac{dH}{{dr}_{2}} )}^{2} \cdot Var [ {r}_{2} ] + {( \frac{dH}{ds} )}^{2} \cdot Var [ s ] \qquad ( Formula 3 )$$

wherein:
r₁: spacing between a first transmitter position and the object in the transmitting and receiving direction;
r₂: spacing between a second transmitter position and the object in the transmitting and receiving direction;
s: distance information measured in the horizontal direction as the spacing between the first and second sensor position;

$$\frac{dH}{{dr}_{1}} :$$

first derivative of the height information H according to r₁;

$$\frac{dH}{{dr}_{2}} :$$

first derivative of the height information H according to r₂;
dH/ds: first derivative of the height information H according to s;
Var[r₁]: variance of the spacing between a first transmitter position and the object in the transmitting and receiving direction;
Var[r₂]: variance of the spacing between a second transmitter position and the object in the transmitting and receiving direction;
Var[s]: variance of the distance information measured in the horizontal direction as the spacing between the first and second sensor position.

The first derivative of the height information H according to r₁ is calculated as follows:

$$\frac{dH}{{dr}_{1}} = 2 {r}_{1} - \frac{{r}_{1} ( {r}_{1}^{2} - {r}_{2}^{2} + {s}^{2} )}{{s}^{2}} \qquad ( Formula 4 )$$

The first derivative of the height information H according to r₂ is calculated as follows:

$$\frac{dH}{{dr}_{2}} = \frac{{r}_{2} ( {r}_{1}^{2} - {r}_{2}^{2} + {s}^{20}}{{s}^{2}} \qquad ( Formula 5 )$$

The first derivative of the height information H according to s is calculated as follows:

$$\frac{dH}{ds} = \frac{{( {r}_{1}^{2} - {r}_{2}^{2} + {s}^{2} )}^{2} - 2 {s}^{2} ( {r}_{1}^{2} - {r}_{2}^{2} + {s}^{2} )}{2 {s}^{3}} \qquad ( Formula 6 )$$

Advantageously, multiple measurements carried out by the ultrasonic sensor technology of the vehicle 1, which are carried out for example during an object tracking during the movement of the vehicle, are combined with one another. The respective variance of the items of height information H may be enlisted as a weighting factor.

In the event that a first item of height information H′ and a second item of height information H″ are established, an averaged item of height information may be established by the following formula:

$$\overline{H} = \frac{Var [ {H}^{″} ] \cdot {H}^{′} + Var [ {H}^{′} ] \cdot {H}^{″}}{Var [ {H}^{′} ] + Var [ {H}^{″} ]} \qquad ( Formula 7 )$$

wherein:
   H′: first estimated items of height information from a first measuring cycle;
   H″: second estimated items of height information from a first measuring cycle;
   Var[H′]: variance of the height information in the first measuring cycle;
   Var[H″]: variance of the height information in the second measuring cycle.

The averaged variance may be calculated as follows:

$$\overline{Var [ H ]} = \frac{1}{\frac{1}{Var [ {H}^{′} ]} + \frac{1}{Var [ {H}^{″} ]}} \qquad ( Formula 8 )$$

wherein the following applies:
Var[H′]: variance of the height information in the first measuring cycle;
Var[H″]: variance of the height information in the second measuring cycle.

It should be noted that the items of height information H′, H″ or the variances Var[H′] and Var[H″] may, in each case, refer to a single measuring cycle (i.e., determination of an individual item of height information H by the measurement of spacing information by a sensor at two different sensor positions), but also to multiple measuring cycles, i.e., the items of height information H′, H″ and the variances Var[H′] and Var[H″] may themselves already be averaged values.

Alternatively, the measurements of the items of height information H may also be combined by a method which is based on a weighted least squares method. The weighting factors of such a method may be selected in such a way that they take into account an existing correlation between the two measurements.

After a plurality of items of height information H have been estimated, the height h of the object 3 may be determined based thereon. In particular, a height classification of the object 3 in a height class may be performed.

For example, a height classification may be carried out to the effect that it is checked how high the probability is that the object 3 has a height h in a certain height range.

In the event that the height class is fixed by a lower limit a and an upper limit b, the probability that the height of the object 3 falls within the height class may be calculated by the following formula:

$$p = {\int }_{a}^{b} N ( x , \overline{H} , \overline{Var [ H ]} ) dx \qquad ( Formula 9 )$$

The following applies:
N(x, H̅, V̅a̅r̅[̅H̅]̅): normal distribution of H̅ over x with a variance V̅a̅r̅[̅H̅]̅;
a: lower limit for allocation to the respective height class;
b: upper limit for allocation to the respective height class;
H̅: averaged height information;
V̅a̅r̅[̅H̅]̅: averaged variance.

If the height class does not have a lower or upper limit, i.e., it is the lowest or the highest height class, the lower limit a may assume the value −∞ or the upper limit b may assume the value +∞.

It is understood that the limits a, b of formula 9 likewise have to be squared due to the relationship H=h², i.e., a classification limit of 0.3 m must be converted into a limit of 0.09 m².

Formula 9 assumes that the averaged height information has a uniform distribution over x. However, in reality, the averaged height information frequently deviates from the normal distribution.

FIG. 3 shows an actual distribution of the height information H based on a histogram, wherein the actual height h of the object relative to the sensor was 0.1 m. As may be seen, the distribution is not axisymmetric to a vertical axis, so that no normal distribution of the height information H exists.

In order to compensate for this deviation, the at least one limit a, b may be adjusted by means of a correction function. In particular, a correction function which carries out an adjustment of the at least one limit depending on the spacing information r₁, r₂ and the distance information s may be selected.

Such a correction function may be established, for example, by a simulation or by real data, based on which the dependency of the height information H on the spacing information r₁, r₂ and the distance information s is determined.

As previously described, the distance information s, i.e., the change in the sensor positions P1, P2 along the transmitting and receiving direction of the ultrasonic signal, is needed.

The vehicle movement itself may be determined by information from an odometry unit of the vehicle. However, the direction of movement of the vehicle does not have to coincide with the transmitting and receiving direction of the ultrasonic signal between the ultrasonic sensor and the object.

The distance information s may, for example, be estimated as follows:

The object 3 may be assumed to be a line object, for example. The line object is assumed to be aligned with the transmitting and receiving direction of the ultrasonic sensor 2 in such a way that the transmitting and receiving direction of the ultrasonic sensor 2 runs perpendicularly to the longitudinal axis of the line object. It is therefore likewise assumed that the distance information s is to be measured perpendicularly to the longitudinal axis of the line object. If the direction of movement of the vehicle 1 and the absolute movement thereof are known, the distance information s may be calculated therefrom.

Alternatively, multiple measurements and tracking may be used to determine the object contour as a curved or arbitrarily shaped line or as a polygon or polygon section. In this case, the distance information s may be calculated directly and, indeed, as the difference between the respective sensor position P1, P2 and the line reproducing the object contour.

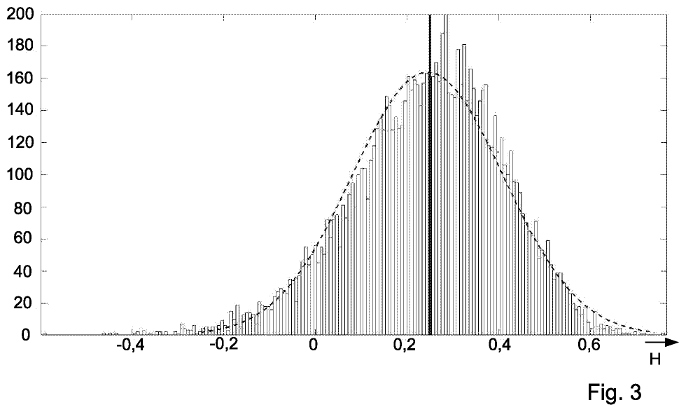

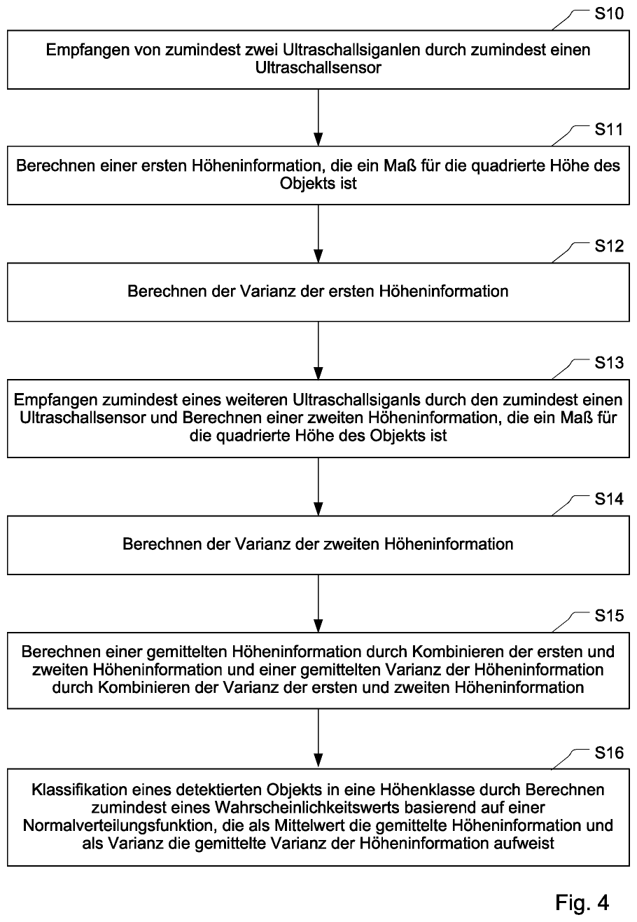

FIG. 4 shows a schematic representation of the steps of a method according to the present disclosure for estimating the height of an object by means of the ultrasonic sensor technology of a vehicle.

Initially, at least two ultrasonic signals are received by at least one ultrasonic sensor 2. A single ultrasonic sensor may have different sensor positions relative to the object due to a vehicle movement. Alternatively, multiple ultrasonic sensors 2 may have different sensor positions relative to the object 3 due to the vehicle movement and/or a different arrangement on the vehicle 1 (S10).

A first item of height information H is then calculated, which is a measure of the squared height h of the object. The calculation is effected based on two items of spacing information r1, r2 measured between the respective sensor position and the object 3, and an item of distance information (s) measured horizontally between the sensor positions (S11).

Subsequently, the variance of the first item of height information is calculated (S12).

At least one further ultrasonic signal is then received by the at least one ultrasonic sensor, and a second item of height information which is a measure of the squared height of the object is calculated based on two items of spacing information measured between the respective sensor position and the object, and an item of distance information measured horizontally between the sensor positions (S13).

Subsequently, the variance of the second height information is calculated (S14).

An averaged item of height information is then calculated by combining the first and second height information and an averaged variance of the height information is calculated by combining the variance of the first and second height information (S15).

Finally, a detected object is classified in a height class by calculating at least one probability value based on a normal distribution function which has as the mean value the averaged height information and as the variance the averaged variance of the height information (S16).

The invention has been described above with reference to example embodiments. It is understood that numerous changes as well as variations are possible, without departing from the scope of protection defined by the claims.

### LIST OF REFERENCE NUMERALS

1 Vehicle
2 Ultrasonic sensor
3 Object
h Height
H Height information
p Probability value
P1 First sensor position
P2 Second sensor position
r1 First spacing information
r2 Second spacing information
S Distance information

1. A method for estimating a height of an object by ultrasonic sensor technology of a vehicle, comprising:
a) receiving, at a computer of a vehicle, at least two ultrasonic signals by at least one ultrasonic sensor, wherein a single ultrasonic sensor has different sensor positions relative to the object due to vehicle movement or wherein multiple ultrasonic sensors have different sensor positions relative to the object due to at least one of the vehicle movement or a different arrangement on the vehicle;
b) calculating by the computer, a first item of height information which is a measure of a squared height of the object, based on two items of spacing information measured between the respective sensor position and the object, and an item of distance information measured horizontally between the sensor positions;
c) calculating, by the computer, a variance of first item of height information;
d) receiving, at the computer, at least one further ultrasonic signal by the at least one ultrasonic sensor and calculating a second item of height information which is a measure of the squared height of the object, based on two items of spacing information measured between the respective sensor position corresponding to the further ultrasonic signal and the object, and an item of distance information measured horizontally between the sensor positions corresponding to the further ultrasonic signal;
e) calculating, by the computer, the variance of the second item of height information;
f) calculating, by the computer, an averaged item of height information by combining the first item of height information and the second item of height information, and an averaged variance of the height information by combining the variance of the first item of height information and the variance of the second item of height information;
g) classifying, by the computer, the object in a height class by calculating, by the computer, at least one probability value based on a normal distribution function which has as a mean value the averaged item of height information and as a variance the averaged variance of the height information.

2. The method according to claim 1, wherein further items of height information, which are a measure of the squared height of the object, and variance information regarding the further items of height information are calculated iteratively, and that the averaged item of height information is determined by combining the items of height information and the averaged variance of the height information is determined by combining the variances of the height information.

3. The method according to claim 2, wherein at least one of the first, second, or further items of height information is/are calculated by the following formula:
$$H = {h}^{2} = {r}_{1}^{2} \begin{matrix}{( {r}_{1}^{2} - {r}_{2}^{2} + {s}^{2} )}^{2} \\ 4 {s}^{2}\end{matrix} ;$$
wherein the following applies:
h: height difference between the at least one ultrasonic sensor and the object;
r₁: spacing between a first transmitter position and the object in transmitting and receiving direction;
r₂: spacing between a second transmitter position and the object in a transmitting and receiving direction of the second transmitter position;
s: distance information measured in the horizontal direction as the spacing between the first sensor position and the second sensor position.

4. The method according to claim 2, wherein the variance of at least one of the first item of height information, the second item of height information, or the further items of height information is established based on a first-order variation analysis.

5. The method according to claim 2, wherein the variance of at least one of the first, second or further items of height information is calculated by the following equation:
$$Var [ H ] = {( \frac{dH}{{dr}_{1}} )}^{2} \cdot Var [ {r}_{1} ] + {( \frac{dH}{{dr}_{2}} )}^{2} \cdot Var [ {r}_{2} ] + {( \frac{dH}{ds} )}^{2} \cdot Var [ s ] ;$$
wherein the following applies:
r₁: spacing between a first transmitter position and the object in a transmitting and receiving direction;
r₂: spacing between a second transmitter position and the object in the transmitting and receiving direction;
s: distance information measured in the horizontal direction as the spacing between the first sensor position and the second sensor position;
$$\frac{dH}{{dr}_{1}} :$$
first derivative of the height information H according to r₁;
$$\frac{dH}{{dr}_{2}} :$$
first derivative of the height information H according to r₂;
dH/ds: first derivative of the height information H according to s;
Var[r₁]: variance of the spacing between a first transmitter position and the object in the transmitting and receiving direction;
Var[r₂]: variance of the spacing between a second transmitter position and the object in the transmitting and receiving direction;
Var[s]: variance of the distance information measured in the horizontal direction as the spacing between the first sensor position and the second sensor position.

6. The method according to claim 1, wherein the averaged item of height information H is calculated based on the following formula:
$$\overline{H} = \frac{Var [ {H}^{″} ] \cdot {H}^{′} + Var [ {H}^{′} ] \cdot {H}^{″}}{Var [ {H}^{′} ] + Var [ {H}^{″} ]} ;$$
wherein the following applies:
H′: estimated items of height information from a first measuring cycle;
H″: estimated items of height information from a second measuring cycle;
Var[H′]: variance of the height information in the first measuring cycle;
Var[H″]: variance of the height information in the second measuring cycle.

7. The method according to claim 1, wherein the averaged variance of the height information H is calculated based on the following formula:
$$\overline{Var [ H ]} = \frac{1}{\frac{1}{Var [ {H}^{′} ]} + \frac{1}{Var [ {H}^{″} ]}} ;$$
wherein the following applies:
H′: estimated items of height information from a first measuring cycle;
H″: estimated items of height information from a second measuring cycle;
Var[H′]: variance of the height information in the first measuring cycle;
Var[H″]: variance of the height information in the second measuring cycle.

8. The method according to claim 1, wherein the averaged item of height information and the averaged variance of the height information are calculated based on a least squares method.

9. The method according to claim 1, wherein the at least one probability value for assigning the object to a height class is calculated based on the following formula:
$$p = {\int }_{a}^{b} N ( x , \overline{H} , \overline{Var [ H ]} ) {dx}_{1}$$
wherein the following applies:
N(x, H̅, V̅a̅r̅[̅H̅]̅): normal distribution;
a: lower limit for allocation to the respective height class;
b: upper limit for allocation to the respective height class;
H̅: averaged item of height information;
V̅a̅r̅[̅H̅]̅: averaged variance of the height information.

10. The method according to claim 1, wherein the height class is calculated based on a correction function which takes into account a deviation of a statistical distribution of the height information from a normal function.

11. The method according to claim 10, wherein the correction function is estimated, based on a stream of height information data which were established based on different items of spacing information between the respective sensor position and the object and different items of horizontally measured distance information.

12. The method according to claim 10, wherein at least one of a lower limit or an upper limit is used for the calculation of the probability value which is adjusted based on the correction function.

13. The method according to claim 1, wherein the object is assumed to be a line object having a longitudinal alignment, and a transmitting and receiving direction of the at least one ultrasonic sensor and a direction in which the distance information is measured is assumed to be perpendicular to the longitudinal alignment of the line object.

14. The method according to claim 1, wherein the object is simulated by items of information, which were established by ultrasonic sensor technology in multiple capturing cycles, by an object contour line, and the items of distance information are assumed to be a difference between a horizontally measured spacing of the sensor positions and the object contour line.

15. A system for estimating a height of an object, utilizing ultrasonic sensor technology provided on a vehicle and comprising a computer, wherein the system is configured to carry out:
a) receiving, by the computer, at least two ultrasonic signals by at least one ultrasonic sensor of ultrasonic sensor technology, wherein a single ultrasonic sensor has different sensor positions relative to the object due to vehicle movement or wherein multiple ultrasonic sensors have different sensor positions relative to the object due to at least one of the vehicle movement or a different arrangement on the vehicle;
b) calculating, by the computer, a first item of height information which is a measure of a squared height of the object, based on two items of spacing information measured between the respective sensor position and the object, and an item of distance information measured horizontally between the sensor positions by the computer unit;
c) calculating a variance of the first item of height information by the computer;
d) receiving, by the computer, at least one further ultrasonic signal by the at least one ultrasonic sensor and calculating a second item of height information which is a measure of the squared height of the object, based on two items of spacing information measured between the respective sensor position corresponding to the at least one further ultrasonic signal and the object, and an item of distance information measured horizontally between the sensor positions;
e) calculating, by the computer, the variance of the second height information;
f) calculating, by the computer, an averaged item of height information by combining the first item of height information and the second item of height information, and an averaged variance of the height information by combining the variance of the first item of height information and the second item of height information; and
g) classifying, by the computer, the object in a height class by calculating at least one probability value by the computer based on a normal distribution function which has as a mean value the averaged item of height information and as a variance the averaged variance of the height information.
